(19) United States
(12) Patent Application Publication
(10) Pub. No.: US 2010/0228595 A1
(43) Pub. Date: Sep. 9, 2010

(54) SYSTEM AND METHOD FOR SCORING TARGET LISTS FOR ADVERTISING

(75) Inventors: Craig E. Dempster, Ridgefield, CT (US); Alptekin Ozgur Dogan, Annapolis, MD (US); Marc C. Fanelli, Kinnelon, NJ (US)

Correspondence Address: WOMBLE CARLYLE SANDRIDGE & RICE, PLLC, ATTN: PATENT DOCKETING, P.O. BOX 7037, ATLANTA, GA, 30357-0037, US

(73) Assignee: Merkle, Inc., Columbia, MD (US)

(21) Appl. No.: 12/398,412

(22) Filed: Mar. 5, 2009

(51) Int. Cl. G06F 17/30; G06Q 30/00; G06Q 90/00

(52) U.S. Cl. 705/10; 705/14.49

(57) ABSTRACT

Various implementations of the invention relate to systems and methods for scoring a plurality of prospective target lists to facilitate an analytic approach, rather than conventional subjective approaches, to selecting one or more of the prospective target lists for purposes of advertising. A plurality of representations representative of one or more desired targeted advertising groups may be created. The prospective target lists may be evaluated against the created representations to develop one or more scores for each prospective target list. Based on the developed scores, one or more target lists from among the plurality of prospective target lists may be recommended and/or selected for advertising purposes.

### FIELD OF THE INVENTION

The invention relates generally to the field of targeted advertising. Specifically, the invention relates to a system and method for scoring a plurality of prospective target lists in order to determine which lists/media/advertisers to select for purposes of advertising.

### BACKGROUND OF THE INVENTION

In the world of targeted advertising, prospective customer data lists are typically selected by or for an entity based on information associated with existing customers of the entity combined with knowledge that brokers (or other third parties, such as, consultancies, agencies, etc.) of the customer data lists have regarding successful and unsuccessful campaigns associated with their customer data lists. The process is primarily subjective.

For media, such as magazines, television, radio, and newspaper, agencies use multiple research collections (e.g., MRI, Arbitron, comScore, Nielsen, etc.) to plan media buying. These research collections typically include relatively small survey universes. The net result is that decisions to purchase advertising are based on little more than self-reported media consumption behavior, age and gender descriptions derived from these small survey universes. These decisions may be flawed and non-optimized, but because it is difficult to gauge true ROI (return on investment) and media productivity for a majority of media types, combined with no other available media targeting method that is deemed superior, the status-quo remains largely unchanged and unchallenged.

These and other drawbacks exist.

### SUMMARY OF THE INVENTION

Various implementations of the invention relate to systems and methods for scoring a plurality of prospective target lists in order to determine which of them to select for purposes of advertising.

A variety of prospective target lists may be generally obtained from various list brokers/data collectors/aggregators/supplier companies. In some implementations, the prospective target lists may include a plurality of prospective customer data lists associated with one or more advertising entities. In some implementations, the prospective customer data lists generally include customer identifiable information, such as, name, postal address, IP address, email address, cookie set on a customer's computer, ZIP code, and/or other customer identifiable information.

In some implementations, the prospective target lists may include a plurality of prospective media audience data lists associated with one or more audience types (e.g., viewer, listener, reader, etc.). In some implementations, the prospective media audience data lists generally include audience identifiable information such as name, postal address, IP address, email address, cookie set on audiences' computer, ZIP code, and/or other audience identifiable information.

In some implementations, a sample target set may be collected from each of the plurality prospective target lists. Each of the sample target sets may be a representative subset, which is less than or equal to the whole, of any given prospective target list. The collected sample target sets may be enhanced with additional customer/audience data which is retrieved using the customer/audience identifiable information in the collected sample target sets.

In some implementations, each of the enhanced collected sample target sets may be evaluated against one or more created representations that are representative of one or more desired targeted advertising groups. Each of the enhanced collected sample target sets may be evaluated against the created representations to develop one or more scores and/or index values for the enhanced collected sample target set. Based on the developed scores and/or index values, one or more target lists from among the prospective target lists may be recommended and/or selected for advertising purposes.

In some implementations, for a given advertising entity, the recommended target lists may be used to identify one or more media types and/or media vehicles that the given advertising entity may wish to use to advertise its products or services to customers.

In some implementations, for a given audience type, the recommended target lists may be used to identify one or more advertising entities that may be pursued for advertising in the media type and/or media vehicle associated with the recommended target lists.

Various other objects, features, and advantages of the invention will be apparent through the detailed description of the preferred embodiments and the drawings attached hereto. It is also to be understood that both the foregoing general description and the following detailed description are exemplary and not restrictive of the scope of the invention.

### BRIEF DESCRIPTION OF THE DRAWINGS

FIG. 1 is an exemplary illustration of a system for scoring a plurality of prospective target lists in order to determine which of them to select for purposes of advertising, according to various implementations of the invention.

FIG. 2 is an exemplary report that is generated by a report generating module, according to various implementations of the invention.

FIG. 3 is an exemplary illustration of a method for scoring a plurality of prospective target lists in order to determine which of them to select for purposes of advertising, according to various implementations of the invention.

### DETAILED DESCRIPTION OF THE INVENTION

Various implementations of the invention relate to systems and methods for scoring each of a plurality of prospective target lists to facilitate an analytic approach, rather than conventional subjective approaches, to selecting one or more of the prospective target lists for purposes of advertising. In some implementations, for a given advertising entity, one or more of the prospective target lists may be selected and used to identify one or more media types and/or media vehicles that the given advertising entity may wish to use to advertise its products or services. In some implementations, for a particular audience type (e.g., viewer, listener, reader, etc.), one or more of the prospective target lists may be selected and used to identify one or more advertising entities that may be pursued for advertising in the media type and/or media vehicle associated with the selected prospective target lists.

A variety of prospective target lists may be generally obtained from various sources. Each of these prospective target lists may be associated with a different media type. Various media types may further include specific media vehicles. Conventional use of subjective criteria results in sub-optimal marketing decisions regarding selection of prospective target lists for advertising. To make better marketing decisions, various implementations of the invention utilize analytical methods to facilitate selection from among the prospective target lists for advertising campaigns.

In some implementations, the prospective target lists may include a plurality of prospective customer data lists associated with one or more advertising entities. In some implementations, one or more of the prospective target lists may be associated with each advertising entity. In some implementations, one or more of the prospective customer data lists may be associated with a same advertising entity. In some implementations, each of the prospective customer data lists may be associated with the same advertising entity.

In some implementations, the prospective customer data lists generally include customer identifiable information, such as, name, postal address, IP address, email address, cookie set on a customer's computer, ZIP code, and/or other customer identifiable information.

In some implementations, the prospective target lists may include a plurality of prospective media audience data lists associated with one or more audience types (e.g., viewer, listener, reader, etc.).

In some implementations, the prospective media audience data lists generally include audience identifiable information such as name, postal address, IP address, email address, cookie set on audiences' computer, ZIP code, and/or other audience identifiable information.

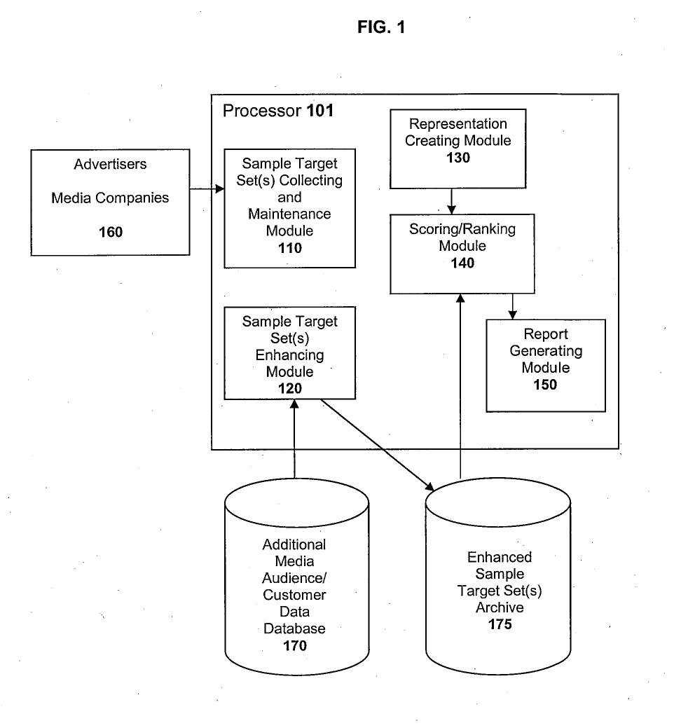

FIG. 1 illustrates an exemplary system for scoring a plurality of prospective target lists in order to determine which of them to select for purposes of advertising, according to various implementations of the invention. System 100 may include one or more processors 101 that may be in operative communication with one or more databases 170, 175. Processor 101 may include one or more software modules operable to cause processor 101 to implement various features and functionality of the invention. For example, the one or more software modules may cause processor 101 to perform functions including one or more of: collecting a sample target set from each of a plurality of prospective target lists, enhancing each collected sample target set with additional customer/audience data, creating one or more representations of one or more desired targeted advertising groups, evaluating each enhanced collected sample target set against the created representations to develop one or more scores for each enhanced collected sample target set, recommending one or more target lists, generating report(s), or other functions. Processor 101 may include one or more computer readable storage media configured to store the one or more software modules, wherein the software modules include computer readable instructions that when executed by processor 101 perform the functions described herein.

Non-limiting examples of modules may include one or more of a sample target set collecting and maintenance module 110, sample target set enhancing module 120, representation creating module 130, scoring/ranking module 140, report generating module 150, and/or other modules. In some implementations of the invention, one or more of the modules may be combined with one another. In some implementations of the invention, not all modules may be necessary.

Databases 170, 175 may include or interface to, one or more databases or other data storage or query formats, platforms, or resources for storing (and retrieving) various types of data, as described in greater detail herein. Database 170 may store additional customer/audience data such as purchase history, customer profile, demographic data, psychographic data, credit data, census data, and/or other additional customer/audience data. In some implementations, the additional customer/audience data may be retrieved from one or more sources. Database 175 may also store certain enhanced data associated with the customer/audience data as discussed in further detail below.

In some implementations of the invention, a sample target set collecting and maintenance module 110 may collect a sample target set from each of the plurality of prospective target lists. In some implementations of the invention, a sample target set collecting and maintenance module 110 may collect a sample target set from each of the plurality of prospective customer data lists and/or each of the plurality of prospective media audience data lists. In some implementations, the entire prospective target list (as opposed to just a sample) may be collected. In some implementations, the entire prospective target list associated with an advertising entity, an audience type, a media type and/or a media vehicle may be collected.

In some implementations of the invention, the prospective customer data lists and the prospective media audience data lists may be provided by various advertisers and media companies 160. In some implementations of the invention, each of the prospective customer data lists and/or prospective media audience data lists may be associated with a different media type and each of the different media types may include one or more specific media vehicles. For example, one prospective customer data list and/or prospective media audience data list may be associated with print media type (e.g., magazines) including media vehicles such as TIME magazine, GOLF DIGEST magazine, and/or other media vehicles; another prospective customer data list and/or prospective media audience data list may be associated with print media type (e.g., newspapers) including media vehicles such as Washington Post, Wall Street Journal, and/or other media vehicles; yet another prospective customer data list and/or prospective media audience data list may be associated with television media type including media vehicles such as ABC, FOX, and the specific program audiences. (i.e. Grey's Anatomy, American Idol, etc.) and/or other media vehicles; and so forth. In some implementations of the invention, for each media type and/or media vehicle, one or more prospective customer data lists and/or one or more prospective media audience data lists may be provided.

In some implementations of the invention, each of the sample target sets may be related to at least one media type. In some implementations of the invention, each of the sample target sets may be related to at least one specific media vehicle of the at least one media type. In some implementations of the invention, each of the sample target sets may include a representative subset of any given prospective customer data list and/or prospective media audience data list.

In some implementations of the invention, the sample target sets collected from the prospective customer data lists may include the same customer identifiable information as in the prospective customer data lists. In some implementations, the sample target sets collected from the prospective media audience data lists may include the same audience identifiable information as in the prospective media audience data lists.

In some implementations of the invention, it may be desirable to enhance the customer/audience information. Hence each of the collected sample target sets may be enhanced with additional customer/audience data to ensure that important customer/audience data variables, such as, geo-demographic, demographics, psychographic, behavioral data, and/or other data variables, are considered. In this way, mere customer/audience personal identifiable data is transformed into enhanced customer/audience data that is predictive, descriptive or has a business value that improves marketing outcomes.

In some implementations of the invention, sample target set enhancing module 120 may enhance each collected sample target set with additional customer/audience data. In some implementations of the invention, the additional customer/audience data may be obtained from database 170. In some implementations of the invention, the additional customer/audience data may be retrieved using the customer/audience identifiable information obtained from the collected sample target sets. In some implementations of the invention, the sample target set enhancing module 120 may augment the collected sample target sets with the additional customer/audience data. In some implementations of the invention, the additional customer/audience data may include purchase history, customer profile, demographic data, psychographic data, credit data, census data, and/or other customer/audience data. In some implementations of the invention, at least a portion of the additional customer/audience data may be retrieved from one or more sources.

In some implementations, the sample target set enhancing module 120 may enhance each sample target set collected from the prospective customer data lists with additional customer data from database 170. In some implementations, the sample target set enhancing module 120 may enhance each sample target set collected from the prospective media audience data lists with additional audience data from database 170.

In some implementations, the sample target set collecting and maintenance module 110 may run various data standardization algorithms on the collected sample target sets prior to the enhancing operations performed by sample target set enhancing module 120.

In some implementations, the enhanced collected sample target sets are catalogued and stored in database 175. In some implementations, the enhanced collected sample target sets include the enhanced sample target sets associated with sample target sets collected from the prospective customer data lists (referred to as enhanced sample customer data sets, hereinafter), and the enhanced sample target sets associated with the sample target sets collected from the prospective media audience data lists (referred to as enhanced sample audience data sets, hereinafter).

In some implementations, representation creating module 130 may create a plurality of representations representative of one or more desired targeted advertising groups. In some implementations of the invention, each desired targeted advertising group may include a target population of interest. In some implementations, for each desired targeted advertising group, one or more different types of representations may be created. The different types of representations may include, but not be limited to, models, attribute lists, statistical algorithms, rules, and/or other representation types.

In some implementations, each of the one or more desired targeted advertising groups may be associated with one or more advertising entities.

In some implementations of the invention, representation creating module 130 may create the representations based on customer data associated with one or more existing customers of one or more advertising entities. In some implementations of the invention, an advertising entity may be any entity that desires to advertise its products or services via one or more media types (provided by one or more media companies). In some implementations of the invention, the one or more media types may include cable media, television media, print media (e.g., magazines, newspapers, and/or other print media), inserts media (e.g., billing inserts, package inserts, and/or other inserts media), internet media, direct mail media, and/or other media types.

In some implementations of the invention, representation creating module 130 may create a plurality of customer representations based on various criteria including media type or other criteria.

In some implementations of the invention, a customer representation created by representation creating module 130 may include a cloning (i.e., customer “look alike”) model. A cloning model may find a population that is similar to the desired target population of interest.

In some implementations of the invention, a customer representation may include a customer-segment specific representation (which models customers per various demographic, behavioral, or other cohorts of interest). In some implementations of the invention, a customer representation may include a customer-product specific representation (which models customers based on the product(s) they buy). For example, a customer representation might be created to identify prospective customers who are likely to open a checking account and/or apply for a mortgage with a retail bank, etc.

In some implementations of the invention, various parametric and/or non-parametric statistical modeling techniques may be used by representation creating module 130 to create the representations. In some implementations of the invention, decision tree modeling techniques may be used, for example, CHAID (Chi-Squared Automatic Interaction Detection), CART (Classification and Regression Trees), and/or other such techniques. These techniques use a graph or model of decisions and their possible consequences, including chance event outcomes, resource costs, and utility. These techniques are well known in the art and will not be described in detail herein.

In some implementations of the invention, regression modeling techniques may be used, for example, linear regression, nonlinear regression and/or other such techniques. Regression modeling establishes a relationship between independent variables (predictor variables) and a dependent variable (variable to be predicted). These techniques are well known in the art and will not be described in detail herein.

In some implementations of the invention, neural network modeling techniques may be used. Neural networks may be used when the exact nature of the relationship between inputs and output is not known. A key feature of neural networks is that they learn relationships between inputs and output through training. These techniques are well known in the art and will not be described in detail herein. In some implementations of the invention, genetic algorithm modeling techniques may be used. Genetic algorithm is a search technique used in computing to find exact or approximate solutions to optimization and search problems. These techniques are well known in the art and will not be described in detail herein.

In some implementations of the invention, the modeling techniques may utilize identified metrics of interest to create the representations. In some implementations of the invention, the identified metrics may include response or conversion, revenue or donation amount, profitability measures, return on investment, and/or other metrics.

In some implementations of the invention, a representation may depend on the planned media and program objectives for an advertising entity. For example, an insurance offer that seeks to maximize responders to a specific offer will be driven by a representation with different characteristics than an insurance promotion where the goal is to maximize “converters”—those that will not only respond but will also purchase the insurance.

In some implementations, the representations may be associated with one or more audience types (e.g., viewer, listener, reader, etc.).

In some implementations of the invention, a scoring/ranking module 140 may evaluate each enhanced collected sample target set against the one or more created representations to develop one or more scores and/or index values for each enhanced collected sample target set. In some implementations, the scoring/ranking module 140 may predict the relevance of each enhanced collected sample target set to the created representations, and develop one or more scores for each enhanced collected sample target set based on the predicted relevance.

In some implementations, for a particular advertising entity, scoring/ranking module 140 may extract each enhanced sample customer data set associated with the particular advertising entity from the database 175, and may evaluate each extracted enhanced sample customer data set against one or more created representations associated with the particular advertising entity to develop one or more scores and/or index values for the extracted enhanced sample customer data set.

In some implementations, for a particular audience type (e.g., viewer, listener, reader, etc.), scoring/ranking module 140 may extract each enhanced sample audience data set associated with the particular audience type, and may evaluate each extracted enhanced sample audience data set against one or more created representations associated with one or more advertising entities and/or one or more audience types to develop one or more scores and/or index values for the extracted enhanced sample audience data set.

In some implementations of the invention, the created representations may be evaluated against enhanced sample customer data sets and/or enhanced sample audience data sets of different media types and/or different media channels to obtain an objective measurement with which to evaluate particular target lists from among the plurality of prospective customer data lists and/or the plurality of prospective media audience data lists.

In some implementations of the invention, each enhanced collected sample target set may be evaluated against each of the plurality of representations created by representation creating module 130.

In some implementations of the invention, scoring/ranking module 140 may evaluate each prospective customer/media audience data list against each of the plurality of representations.

In some implementations of the invention, scoring/ranking module 140 may place the consumers in the each enhanced collected sample target set into deciles, or other segments (percentiles, quartiles, etc.) based on the score distributions.

In some implementations of the invention, scoring/ranking module 140 may, for a given representation, individually rank each enhanced collected sample target set based on the scores and/or index values.

In some implementations of the invention, scoring/ranking module 140 may score a baseline random sample (e.g. national random sample) for benchmarking and index creation.

In some implementations of the invention, scoring/ranking module 140 may, for a given representation, individually rank each enhanced collected sample target set based on estimated response performance. In some embodiments, scoring/ranking module 140 may, for a given representation, rank each enhanced collected sample target set based on average model decile and the scores and/or index values.

In some implementations of the invention, scoring/ranking module 140 may subsequently recommend and/or select for advertising purposes one or more target lists from among the plurality of prospective target lists based on the developed one or more scores and/or index values. In some implementations, scoring/ranking module 140 may subsequently recommend and/or select for advertising purposes one or more customer data lists from among the plurality of prospective customer data lists based on the one or more scores and/or index values associated with the extracted enhanced sample customer data sets. In some implementations, scoring/ranking module 140 may subsequently recommend and/or select for advertising purposes one or more media audience data lists from among the plurality of prospective media audience data lists based on the one or more scores and/or index values associated with the extracted enhanced sample audience data sets.

In some implementations, the developed scores and/or index values combined with other external data (for example, media channel cost, reach, competitive usage, and/or other external data) may be leveraged by the scoring/ranking module 140 to subsequently recommend and/or select the customer/media audience data lists.

In some implementations of the invention, the recommended customer data lists may be selected for purchase and used for advertising the products or services of the particular advertising entity. For example, the recommended customer data lists may identify one or more media types and/or media vehicles that the particular advertising entity may wish to use to advertise its products or services to customers.

In some implementations of the invention, scoring/ranking module 140 may recommend one or more customer data lists to identify targeted advertisers from among the plurality of prospective customer data lists based on the developed one or more scores.

In some implementations of the invention, the recommended media audience lists may be selected for purchase and used for identifying, for a particular media type and/or media vehicle utilized by the particular audience type, one or more advertising entities that should be pursued for advertising. In some implementations, the recommended media audience lists may be used to identify one or more advertising entities that may be pursued for advertising in the media type and/or media vehicle associated with the recommended media audience lists.

In some implementations of the invention, scoring/ranking module 140 may recommend one or more media audience data lists/media types from among the plurality of prospective media audience data lists for targeted advertising placement based on the developed one or more scores.

In some implementations of the invention, the recommended target lists may be selected for advertising campaigns. In some implementations of the invention, the recommended target lists may be used for follow on testing and evaluation such as direct mail campaigns.

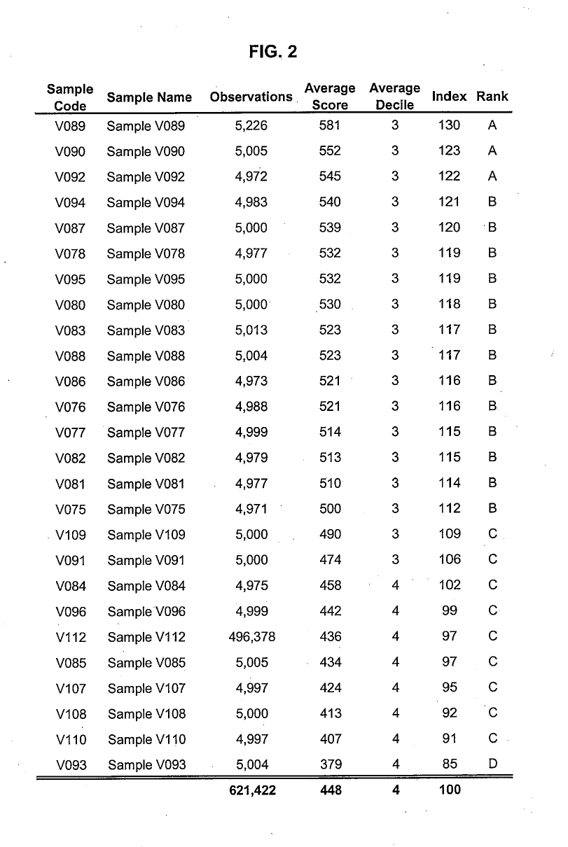

In some implementations of the invention, reporting module 150 may generate a report with the rankings, as illustrated in FIG. 2, for example, where:

Rank A: index>121% (great)

Rank B: index between 110%-121% (above average)

Rank C: index between 91%-109% (average)

Rank D: index between 80%-90% (below average)

Rank E: index<80% (poor)

Other rankings, scores, or designations may be used as would be apparent.

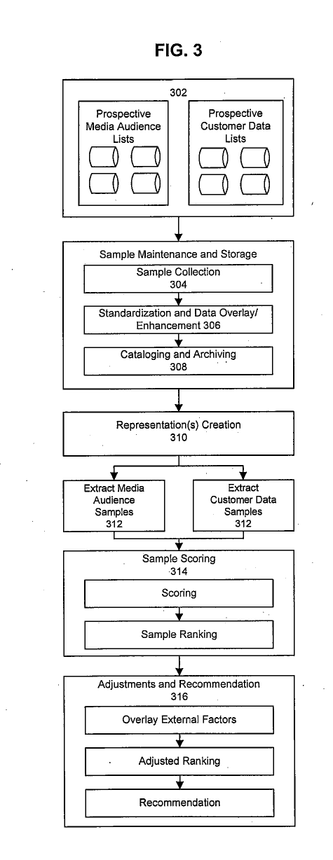

FIG. 3 illustrates an exemplary method for scoring a plurality of prospective target lists in order to determine which of them to select for purposes of advertising, according to various implementations of the invention.

In some implementations of the invention, in operation 302, a variety of prospective target lists may be obtained from various sources. In some implementations, the prospective target lists may be obtained from various advertisers and media companies 160. In some implementations, the prospective target lists may include a plurality of customer data lists associated with one or more advertising entities. In some implementations, the prospective target lists may include a plurality of media audience data lists associated with one or more audience types (e.g., viewer, reader, listener, etc.).

In some implementations of the invention, in operation 304, a sample target set may be collected from each of the plurality of prospective target lists (e.g., by sample target set collecting and maintenance module 110, as described in detail above). In some implementations of the invention, a sample target set from each of the plurality of prospective customer data lists and/or each of the plurality of prospective media audience data lists may be collected. In some implementations, the entire prospective target list (as opposed to just a sample) may be collected. In some implementations, the entire prospective target list associated with an advertising entity, an audience type, a media type and/or a media vehicle may be collected.

In some implementations of the invention, in operation 306, various data standardization algorithms may be applied to the collected sample target sets (e.g., by sample target set collecting and maintenance module 110). Also, in operation 306, each collected sample target set may be enhanced with additional customer/audience data (e.g., by sample target set enhancing module 120, as described in detail above). In some implementations, each sample target set collected from the prospective customer data lists may be enhanced with additional customer data. In some implementations, each sample target set collected from the prospective media audience data lists may be enhanced with additional audience data.

In some implementations of the invention, in operation 308, the enhanced collected sample target sets are catalogued and stored in database 175 (e.g., by sample target set enhancing module 120). In some implementations, the enhanced collected sample target sets include the enhanced sample customer data sets and the enhanced sample audience data sets.

In some implementations of the invention, in operation 310, a plurality of representations representative of one or more desired targeted advertising groups may be created (e.g., by representation creating module 130, as described in detail above).

In some implementations of the invention, in operation 312, each enhanced sample customer data set associated with a particular advertising entity may be extracted from database 175 (e.g., by scoring/ranking module 140, as described in detail above). In some implementations, in operation 312, each enhanced sample audience data set associated with a particular audience type may be extracted from database 175 (e.g., by scoring/ranking module 140, as described in detail above).

In some implementations of the invention, in operation 314, each extracted enhanced sample customer data set may be evaluated against one or more created representations associated with the particular advertising entity to develop one or more scores and/or index values for the extracted enhanced sample customer data set (e.g., by scoring/ranking module 140, as described in detail above).

In some implementations of the invention, in operation 314, each extracted enhanced sample audience data set may be evaluated against one or more created representations associated with one or more advertising entities to develop one or more scores and/or index values for the extracted enhanced sample audience data set (e.g., by scoring/ranking module 140, as described in detail above).

In some implementations of the invention, in operation 314, for a given representation, each extracted enhanced sample customer/audience data set may be individually ranked based on the scores and/or index values associated therewith (e.g., by scoring/ranking module 140).

In some implementations of the invention, in operation 316, one or more target lists from among the plurality of target lists may be recommended and/or selected based on the developed one or more scores and/or index values (e.g., by scoring/ranking module 140, as described in detail above). In some implementations, one or more customer data lists from among the plurality of prospective customer data lists may be recommended and/or selected based on the one or more scores and/or index values associated with the extracted enhanced sample customer data sets. In some implementations, one or more media audience data lists from among the plurality of prospective media audience data lists may be recommended and/or selected based on the one or more scores and/or index values associated with the extracted enhanced sample audience data sets.

In some implementations of the invention, the developed scores and/or index values may be combined with other external data/factors (for example, media channel cost, reach, competitive usage, and/or other external data/factors). The ranking of each extracted enhanced sample customer/audience data set may be adjusted to reflect these external data/factors. In some implementations, the developed scores and/or index values combined with the external data/factors maybe leveraged by scoring/ranking module 140 to subsequently recommend and/or select the customer/media audience data lists.

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A method for scoring a plurality of prospective target lists in order to determine which of them to select for purposes of targeted advertising, the method comprising:
creating a plurality of representations representative of one or more desired targeted advertising groups;
collecting a sample target set from each of a plurality of prospective target lists, each of the plurality of prospective target lists associated with a different media type, each of the different media types having one or more specific media vehicles, each sample target set related to at least one media type or at least one specific media vehicle of at least one media type, each sample target set including a representative subset, which is less than or equal to the whole, of the prospective target list;
enhancing each collected sample target set with additional customer and/or audience data, the additional customer and/or audience data retrieved using customer and/or audience identifiable information obtained from the collected sample target sets;
evaluating each enhanced collected sample target set against the created representations to develop one or more scores for each enhanced collected sample target set; and
recommending one or more target lists for targeted advertising from among the plurality of prospective target lists based on the developed one or more scores.

2. The method of claim 1, wherein the plurality of prospective target lists may include a plurality of prospective customer data lists associated with one or more advertising entities, and the method further comprising:
collecting a sample target set from each of the plurality of prospective customer data lists;
enhancing each collected sample target set collected from each of the plurality of customer data lists with additional customer data;
extracting each enhanced collected sample target set associated with a particular advertising entity;
evaluating each extracted enhanced collected sample target set against one or more of the created representations associated with the particular advertising entity to develop one or more scores for each extracted enhanced collected sample target set; and
recommending one or more customer data lists to identify targeted advertisers from among the plurality of prospective customer data lists based on the developed one or more scores.

3. The method of claim 1, wherein the plurality of prospective target lists may include a plurality of prospective media audience data lists associated with one or more audience types, and the method further comprising:
collecting a sample target set from each of the plurality of prospective media audience data lists;
enhancing each collected sample target set collected from each of the plurality of media audience data lists with additional audience data;
extracting each enhanced collected sample target set associated with a particular audience type;
evaluating each extracted enhanced collected sample target set against one or more of the created representations associated with one or more audience types to develop one or more scores for each extracted enhanced collected sample target set; and
recommending one or more media audience data lists/media types from among the plurality of prospective media audience data lists for targeted advertising placement based on the developed one or more scores.

4. The method of claim 1, wherein the additional customer and/or audience data is retrieved from one or more sources.

5. The method of claim 1, wherein evaluating each enhanced collected sample target set against the created representations further comprises:
predicting the relevance of each enhanced collected sample target set to the created representations; and
developing one or more scores for each enhanced collected sample target set based on the predicted relevance.

6. A system for scoring a plurality of prospective target lists in order to determine which of them to select for purposes of targeted advertising, the system comprising:
one or more processors comprising computer readable storage media, the computer readable storage media configured to store one or more software modules comprising computer readable instructions, the one or more software modules comprising:
a representation creating module comprising computer readable instructions which when executed by the one or more processors are configured to create a plurality of representations representative of one or more desired targeted advertising groups;
a sample target set collecting and maintenance module comprising computer readable instructions which when executed by the one or more processors are configured to collect a sample target set from each of a plurality of prospective target lists, each of the plurality of prospective target lists associated with a different media type, each of the different media types having one or more specific media vehicles, each sample target set related to at least one media type or at least one specific media vehicle of the at least one media type, each sample target set including a representative subset, which is less than or equal to the whole, of the prospective target list;
a sample target set enhancing module comprising computer readable instructions which when executed by the one or more processors are configured to enhance each collected sample target set with additional customer and/or audience data, the additional customer and/or audience data retrieved using customer and/or audience identifiable information obtained from the collected sample target sets;
a scoring/ranking module comprising computer readable instructions which when executed by the one or more processors are configured to:
evaluate each enhanced collected sample target set against the created representations to develop one or more scores for each enhanced collected sample target set; and
recommend one or more target lists from among the plurality of prospective target lists based on the developed one or more scores.

7. The system of claim 6, wherein the plurality of prospective target lists may include a plurality of prospective customer data lists associated with one or more advertising entities, and the system further comprising:
the sample target set collecting and maintenance module comprising computer readable instructions which when executed by the one or more processors are further configured to collect a sample target set from each of the plurality of prospective customer data lists;
the sample target set enhancing module comprising computer readable instructions which when executed by the one or more processors are further configured to enhance each collected sample target set collected from each of the plurality of customer data lists with additional customer data; and
the scoring/ranking module comprising computer readable instructions which when executed by the one or more processors are further configured to:
extract each enhanced collected sample target set associated with a particular advertising entity;
evaluate each extracted enhanced collected sample target set against one or more of the created representations associated with the particular advertising entity to develop one or more scores for each extracted enhanced collected sample target set; and
recommend one or more customer data lists for identifying targeted advertisers from among the plurality of prospective customer data lists based on the developed one or more scores.

8. The system of claim 6, wherein the plurality of prospective target lists may include a plurality of prospective media audience data lists associated with one or more audience types, and the system further comprising:
the sample target set collecting and maintenance module comprising computer readable instructions which when executed by the one or more processors are further configured to collect a sample target set from each of the plurality of prospective media audience data lists;
the sample target set enhancing module comprising computer readable instructions which when executed by the one or more processors are further configured to enhance each collected sample target set collected from each of the plurality of media audience data lists with additional audience data; and
the scoring/ranking module comprising computer readable instructions which when executed by the one or more processors are further configured to:
extract each enhanced collected sample target set associated with a particular audience type;
evaluate each extracted enhanced collected sample target set against one or more of the created representations associated with one or more audience types to develop one or more scores for each extracted enhanced collected sample target set; and
recommend one or more media audience data lists from among the plurality of prospective media audience data lists based on the developed one or more scores.

9. The system of claim 6, wherein the additional customer and/or audience data is retrieved from one or more sources.

10. The system of claim 6, wherein evaluating each enhanced collected sample target set against the created representations comprises the scoring/ranking module comprising computer readable instructions which when executed by the one or more processors are further configured to:
predict the relevance of each enhanced collected sample target set to the created representations; and
develop one or more scores for each enhanced collected sample target set based on the predicted relevance.
